(19) United States
(12) Patent Application Publication
(10) Pub. No.: US 2023/0115681 A1
(43) Pub. Date: Apr. 13, 2023

(54) NITROGEN-DOPED POROUS CARBON MATERIAL AND PREPARATION METHOD AND APPLICATION THEREOF

(71) Applicant: SHANDONG UNIVERSITY, Jinan, Shandong (CN)

(72) Inventors: Kuihua HAN, Jinan (CN); Jianhui QI, Jinan (CN); Shengli NIU, Jinan (CN); Xiaofeng ZHANG, Jinan (CN); Jigang ZHANG, Jinan (CN); Jinxiao LI, Jinan (CN); Zhaocai TENG, Jinan (CN); Meimei WANG, Jinan (CN); Ming LI, Jinan (CN); Tongtong JI, Jinan (CN); Yang CAO, Jinan (CN)

(73) Assignee: SHANDONG UNIVERSITY, Jinan, Shandong (CN)

(21) Appl. No.: 17/049,802

(22) PCT Filed: Nov. 5, 2019
(86) PCT No.: PCT/CN2019/115808

§ 371 Date: Oct. 22, 2020

(30) Foreign Application Priority Data
Aug. 12, 2019 (CN) 201910739372.9

(51) Int. Cl. C01B 32/324; H01G 11/34

(52) U.S. Cl. CPC C01B 32/324; H01G 11/34; B82Y 30/00

(57) ABSTRACT

A nitrogen-doped porous carbon material and a preparation method and an application thereof; wherein the nitrogen-doped porous carbon material has a specific surface area of 1600-3500 m²·g⁻¹, mesopores with a pore size of 2-50 nm account for 20-40% of all pores, an average pore size is 2-20 nm, and a mass fraction of nitrogen atoms in the porous carbon material is 13.6-19.3 wt %. When being used as a supercapacitor material, the porous carbon material has a larger specific capacitance and a better capacitance retention rate. At a current density of 0.1 A·g⁻¹, the porous carbon material has a specific capacitance of about 847 F·g⁻¹. After 5000 cycles of charging and discharging, the capacitance retention rate is about 99.7%. Moreover, the porous carbon material features an excellent pore structure distribution, thus providing good CO₂ adsorption performance.

### BACKGROUND

### Technical Field

The present invention belongs to the field of porous carbon material preparation technologies, and specifically, to a nitrogen-doped porous carbon material and a preparation method and an application thereof.

### Related Art

Information disclosed in the related art section is merely for better understanding of the overall background of the present invention, and should not be taken as an acknowledgement or any suggestion that the information constitutes the prior art that is well known to those of ordinary skill in the art.

A supercapacitor is a novel third-generation energy storage device after mechanical energy storage and chemical energy storage. It has a power density which is 10-100 times that of a battery, can achieve high-current charging and discharging, and has the characteristics of high charging and discharging efficiency and a long cycle life. The supercapacitor is highly demanded in the fields such as electronic products, power systems, vehicles, rail transit, aeronautics and astronautics, and has become a hot spot for studies of green energy conversion and secondary energy storage devices.

Porous carbon is the first choice material for current commercial supercapacitor due to its advantages of a large specific surface area, a well-developed pore structure and good conductivity. The specific capacitance of a carbon material can be increased to a certain extent by increasing the specific surface area, but the relationship between the electricity storage performance and the specific surface area is not a simple linear one. A purer carbon material has fewer functional groups on its surface, resulting in that its high specific surface area cannot be fully utilized. Therefore, the method of increasing the specific capacitance of the carbon material only by increasing the specific surface area has great limitations. Modifying the carbon material by heteroatom doping is an effective method for improving the performance of the porous carbon material. Nitrogen and carbon atoms have similar atomic radii. During doping, the structure of carbon is not easily destroyed, and a six-membered ring structure of the carbon can be changed to a five-membered ring structure to cause changes in the surface structure, hydrophilicity and conductivity of the material, thereby greatly expanding the application fields of the carbon material.

Chinese Patent No. CN 108922794 A disclosed a method for preparing a nitrogen-doped biomass-based activated carbon electrode material. In this method, the doping process is conducted before the thermochemical treatment process, so a large amount of the nitrogen source material is consumed; and the thermochemical treatment requires a high temperature and lasts for a long time, greatly increasing the costs of the preparation process. The specific surface area of the carbon material prepared by this method is 825.3 m²·g⁻¹. At a current density of 0.5 A·g⁻¹, the specific capacitance is 259 F·g⁻¹, which still cannot meet the criteria which current high-performance capacitor carbon needs to meet.

Chinese Patent No. CN 108622877 A disclosed a nitrogen-doped porous carbon material having a hierarchical pore structure and a preparation method and an application thereof. This method uses cellulosic biomass as the raw material and organic matter urea and glycine as nitrogen sources and includes steps such as nitrogen source pretreatment, maxing of carbon and nitrogen sources, low-temperature carbonization, and high-temperature activation, which involves a complex process and consumes a large amount of the nitrogen source material. The specific surface area of the carbon material prepared by this method is 2600 m²·g⁻¹. At a current density of 3 A·g⁻¹, the specific capacitance is 210 F·g⁻¹, which cannot meet the criteria which current high-performance capacitor carbon needs to meet.

Chinese Patent No. CN 108483442 A disclosed a method for preparing a high-mesoporosity nitrogen-doped carbon electrode material with bamboo shoot shell. This method includes steps of hydrothermal pretreatment, simultaneous low-temperature carbonization and nitrogen doping, and activation treatment, which involves a complex process and consumes a large amount of the nitrogen source material. At a current density of 0.5 A·g⁻¹, the specific capacitance is 209 F·g⁻¹, which cannot meet the criteria which current high-performance capacitor carbon needs to meet.

Chinese Patent No. CN 109319778 A disclosed a preparation method and an application of a nitrogen-doped pine nut shell-based porous carbon material, where chain nitrogen sources such as semicarbazide, urea, and guanidine carbonate are used as the nitrogen source material, a large amount of dopant material is consumed, and the doping effect is not obvious. The pretreatment process adopts a low-temperature carbonization process, which cannot completely remove volatiles in the raw material, and there are still a large number of H and O atoms in the carbonized product, resulting in low efficiency in the doping process. At a current density of 0.5 A·g⁻¹, the specific capacitance is 278-380 F·g⁻¹, and there is still room for further improvement.

In the current related studies and patents, although a specific surface area of 300-2800 m²·g⁻¹ and a specific capacitance of up to 100-380 F·g⁻¹ can be obtained by treating the biomass raw material, there are still problems such as a complex preparation process, an unreasonable process flow, lack of diversified carbonaceous precursor raw materials, consumption of a large amount of nitrogen source material, low efficiency in nitrogen doping, and an unstable doping structure. The specific capacitance still cannot meet the criteria which current high-performance capacitor carbon needs to meet, and the doping method is complex and not environmentally friendly.

### SUMMARY

In view of the above technical problems in the prior art, objectives of the present invention are to provide a nitrogen-doped porous carbon material and a preparation method and an application thereof.

In order to resolve the above technical problems, the present invention adopts the following technical solution.

A first objective of the present invention is to provide a nitrogen-doped porous carbon material, having a specific surface area of 1600-3500 m²·g⁻¹, wherein mesopores with a pore size of 2-50 nm account for 20-40% of all pores, an average pore size is 2-20 nm, and a mass fraction of nitrogen atoms in the porous carbon material is 13.6-19.3 wt %, which is much higher than those in current related patents. The high nitrogen content can effectively improve the surface structure, conductivity and wettability of the material, thereby improving the electrochemical performance and the adsorption performance of the material.

When being used as a supercapacitor material, the porous carbon material has a larger specific capacitance and a better capacitance retention rate. At a current density of 0.1 A·g⁻¹, the porous carbon material has a specific capacitance of about 847 F·g⁻¹. After 5000 cycles of charging and discharging, the capacitance retention rate is about 99.7%.

Moreover, the porous carbon material features an excellent pore structure distribution, thus providing good CO₂ adsorption performance.

A second objective of the present invention is to provide a method for preparing a nitrogen-doped porous carbon material, including the following steps:

washing, drying and pulverizing a carbonaceous precursor to obtain biomass powder;

carbonizing the biomass powder at high temperature in an inert gas or ammonia gas atmosphere, to obtain a carbonized product, wherein the temperature of carbonization is 600-800° C.;

ultrasonically mixing and impregnating the carbonized product, a saturated chemical activator solution, and a nitrogen source material, wherein the nitrogen source material is melamine, polyaniline and pyridine; and

heating the impregnated product in an inert atmosphere for hybridization to obtain biomass nitrogen-doped porous carbon.

Because the step of high-temperature carbonization is used in the preparation process of the present invention, more volatiles and H and O atoms are removed during the carbonization, thereby providing more active sites. The carbonized product is more easily bonded with N atoms in further reactions, thereby improving the efficiency of nitrogen doping, and reducing the amount of nitrogen source material required. Moreover, the high-temperature carbonization endows the carbonized product with a higher porosity and a large pore size, which increases the contact area between the carbon material and the activator and dopant material, thereby facilitating the progress of the reaction.

The ammonia gas can provide amino to assist with the nitrogen doping process. When the volatiles are separated out, nitrogen can be bonded with the active sites left vacant on the carbon ring in a timely manner.

By heating the impregnated product in the inert atmosphere for hybridization, nitrogen atoms replace carbon atoms on the carbon ring, and a part of a five-membered ring structure is formed.

The inventor has found through experiments that a ring nitrogen source has higher stability than a chain nitrogen source; when the ring nitrogen source such as melamine, polyaniline and pyridine is used for nitrogen doping of the porous carbon, a better stability of the porous carbon material can be achieved by optimizing parameters of the preparation process, and there is no significant decrease in the specific capacitance even after thousands of times of charging and discharging.

The ultrasonic treatment on the impregnated system can effectively promote mixing of the chemical activator and the nitrogen source material, thereby avoiding overly complex material pretreatment procedures (such as impregnation and mixing at high temperature, impregnation and mixing in a dilute solution followed by evaporation to dryness, and pretreatment of the nitrogen source material followed by impregnation and mixing), greatly shortening the treatment time, and improving the treatment efficiency.

Under the joint action of the high-temperature carbonization, ultrasonic impregnation and heating in the inert atmosphere for hybridization, the amount of biomass nitrogen doped in the porous carbon is greatly increased.

In some embodiments, the carbonaceous precursor includes but is not limited to garlic stalk, sargassum, wood sawdust, fruit shell and straw.

In some embodiments, the carbonaceous precursor is passed through an 80 mesh sieve after being pulverized. An excessively large particle size causes inadequate reaction of the material in subsequent steps, and an excessively small particle size leads to increased preparation costs of the material.

In some embodiments, the time of the carbonization is 1.5-2.5 h.

In some embodiments, the saturated chemical activator solution is a KOH saturated solution. The nitrogen source material in the present invention is insoluble in water, an excessively low concentration affects the efficiency of the impregnation process, and the KOH saturated solution can ensure the full infiltration with KOH.

Further, a mass ratio of the carbonized product, the saturated chemical activator solution and the nitrogen source material is 1-3:1-5:0.1-2. The amount of the nitrogen source material used in the present invention is small, a good nitrogen doping effect can be achieved.

Further, the temperature of the ultrasonic impregnation is room temperature.

Further, the frequency of the ultrasonic treatment is 10-50 kHz, power of the ultrasonic treatment is 80-150 W, and the time of the ultrasonic treatment is 4-8 min.

In some embodiments, the temperature of the heating is 750-800° C., and the time of the heating is 2-2.5 h.

In some embodiments, the preparation method further includes a step of washing and drying the obtained biomass nitrogen-doped porous carbon. The porous carbon is washed to remove impurities in the porous carbon.

Further, the obtained biomass nitrogen-doped porous carbon is pickled with 10-20 wt % hydrochloric acid, and then is washed to neutrality with deionized water.

A third objective of the present invention is to provide nitrogen-doped porous carbon prepared by the above preparation method.

A fourth objective of the present invention is to provide an application of the above nitrogen-doped porous carbon in preparation of a supercapacitor material.

A fifth objective of the present invention is to provide an activated carbon electrode, where components of the activated carbon electrode include the above nitrogen-doped porous carbon.

Further, the components of the activated carbon electrode further include a conductive agent and a binder, the conductive agent is carbon black, acetylene black, graphite or other conductive additives or is a carbon nanotube additive, and the binder is polytetrafluoroethylene (PTFE), polyvinylidene fluoride (PVDF), polyvinyl alcohol, carboxymethylcellulose sodium, polyolefin, rubber or polyurethane.

A sixth objective of the present invention is to provide a method for preparing the above activated carbon electrode, including the following steps:

adding a solvent to a mixture of the nitrogen-doped porous carbon, the binder and the conductive agent to prepare a slurry;

evenly coating a current collector with the slurry and drying to obtain the activated carbon electrode; or

hot-pressing the slurry to obtain the activated carbon electrode.

In some embodiments, the current collector is a copper foil, aluminum foil, nickel mesh or stainless steel foil.

A seventh objective of the present invention is to provide an application of the above nitrogen-doped porous carbon in a CO₂ adsorbent.

Beneficial effects of the present invention are as follows:

Because the step of high-temperature carbonization is used in the preparation process of the present invention, more volatiles and H and O atoms are removed during the carbonization, thereby providing more active sites. The carbonized product is more easily bonded with N atoms in further reactions, thereby improving the efficiency of nitrogen doping, and reducing the amount of nitrogen source material required. Moreover, the high-temperature carbonization endows the carbonized product with a higher porosity and a large pore size, which increases the contact area between the carbon material and the activator and dopant material, thereby facilitating the progress of the reaction.

The molecular structure of the nitrogen source used in the present invention is ring-shaped, which has higher stability than a chain nitrogen source. The type of nitrogen doping in the porous carbon material prepared by the process of the present invention is mainly pyrrole nitrogen and graphite nitrogen, which has a stable structure. Therefore, after thousands of times of charging and discharging, there is no significant decrease in the specific capacitance of the material.

Optimized process steps are adopted in the present invention to avoid overly complex material pretreatment procedures, and the introduction of ultrasonic treatment to mix the activator and the nitrogen source material greatly shortens the treatment time and improves the treatment efficiency.

The present invention features a simple process, a wide range of raw material sources, low costs, and a readily controllable reaction process, is suitable for scale production, and has a broad application prospect in the fields of supercapacitor electrode materials and CO₂ adsorption materials, which is specifically embodied in the following aspects: (1) The nitrogen-doped porous carbon material prepared by the technical process of the present invention has a three-dimensional hierarchical pore structure with a specific surface area of 1600-3500 m²·g⁻¹. (2) The nitrogen-doped porous carbon material has a larger specific capacitance and better capacitance retention rate. To be specific, when used as a supercapacitor electrode material, the nitrogen-doped porous carbon material has a specific capacitance of 847 F·g⁻¹ at a current density of 0.1 A·g⁻¹, and after 5000 cycles of charging and discharging, the capacitance retention rate is 99.7%. (3) CO₂ adsorption tests show that the adsorption amounts of the nitrogen-doped porous carbon material at 25° C. and 0° C. are respectively as high as 3.59 mmol/g and 6.11 mmol/g, exhibiting an excellent pore structure distribution and an excellent CO₂ adsorption performance.

### BRIEF DESCRIPTION OF THE DRAWINGS

The accompanying drawings that constitute a part of this application are used to provide a further understanding of this application. Exemplary embodiments of this application and descriptions of the embodiments are used for describing this application, and do not constitute any inappropriate limitation to this application.

FIG. 1 is a graph showing a nitrogen adsorption-desorption curve according to Embodiment 1 of the present invention;

FIG. 2 is a graph showing the distribution of pore sizes according to Embodiment 1 of the present invention;

FIG. 3 is a graph showing the cycle performance according to Embodiment 1 of the present invention;

FIG. 4 shows a cyclic voltammetric curve obtained by testing an electrode material prepared in Embodiment 2 of the present invention at a scan rate of 200 mV·s⁻¹;

FIG. 5 shows a constant-current charging and discharging curve obtained by testing the electrode material prepared in Embodiment 2 of the present invention at a current density of 5 A·g⁻¹;

FIG. 6 is a graph showing the rate capability of an electrode material prepared in Embodiment 2 of the present invention; and

FIG. 7 is a scanning electron microscope (SEM) image of a nitrogen-doped porous carbon material prepared in Embodiment 3 of the present invention.

### DETAILED DESCRIPTION

It is to be noted that the following detailed descriptions are all exemplary and are intended to provide a further understanding of this application. Unless otherwise specified, all technical and scientific terms used herein have the same meaning as commonly understood by those of ordinary skill in the art to which this application belongs.

It should be noted that terms used herein are only for describing specific implementations and are not intended to limit exemplary implementations according to this application. As used herein, the singular form is also intended to include the plural form unless the context clearly dictates otherwise. In addition, it should be further understood that, terms “comprise” and/or “include” used in this specification indicate that there are features, steps, operations, devices, components, and/or combinations thereof.

### Embodiment 1

This embodiment relates to a method for preparing nitrogen-doped porous carbon, including the following steps:

Step 1: Garlic stalk as the raw material was washed, placed in a blow drying oven and dried at 120° C. for 48 h, pulverized, and passed through an 80 mesh sieve.

Step 2: The product obtained in the step 1 was placed in a tube furnace for carbonization at 600° C. for 2 h. Nitrogen gas was used as an inert gas.

Step 3: The product obtained in the step 2 was washed and dried.

Step 4: The product obtained in the step 3, a KOH saturated solution and melamine were mixed at a mass ratio of 1:4:0.2, and the mixture was ultrasonically treated for 6 min, wherein the ultrasonic frequency was 40 kHz, and the power was 120 W.

Step 5: The product obtained in the step 4 was placed in a muffle furnace for treatment at 800° C. for 2 h. Nitrogen gas was used as an inert gas.

Step 6: The product obtained in the step 5 was first pickled with hydrochloric acid, and then washed to neutrality with deionized water, and dried to obtain a nitrogen-doped biomass-based porous carbon material.

Implementation effect: The mass ratio of nitrogen atoms of the product is as high as 19.3 wt %. The specific surface area calculated by the BET method is 2642 m²/g, the pore volume is 1.41 cm³/g, and the average pore size is 2.14 nm. The product is a carbon material having a high specific surface area. A constant-current charging and discharging test was performed on a supercapacitor electrode material prepared by mixing the carbon material, a conductive agent and a binder at a mass ratio of 8:1:1, using 6 mol/L KOH as an electrolyte. At a current density of 0.1 A/g, specific capacitance reaches 847 F/g. As shown in FIG. 6, at a current density of 10 A/g, the specific capacitance can still reach 649 F/g.

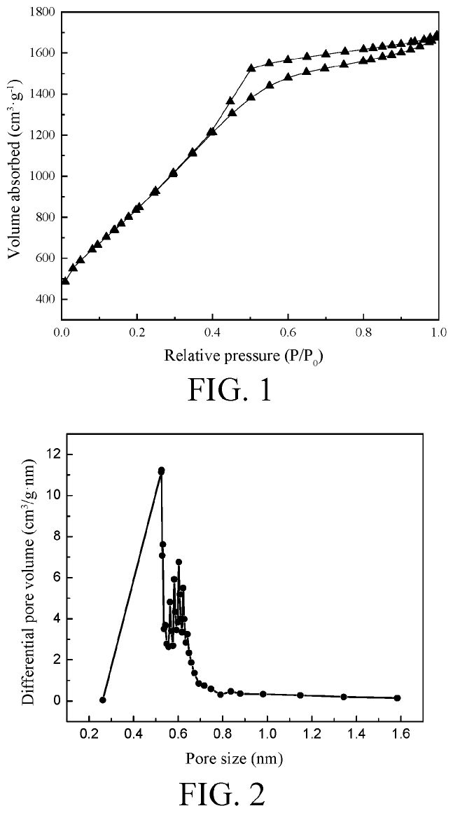

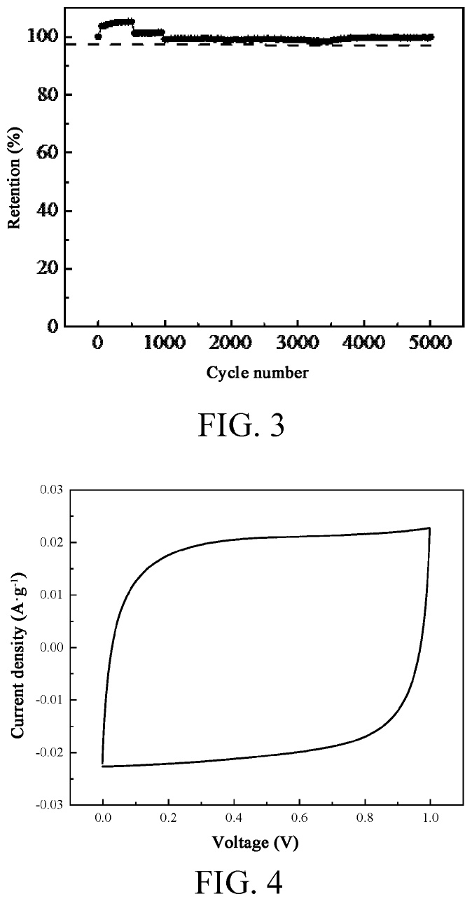

It may be learned from FIG. 1 that an isothermal adsorption-desorption curve of the material shows an obvious hysteresis loop, indicating that the material has a typical three-dimensional hierarchical pore structure. It may be learned from FIG. 2 that the material after being doped still has a large number of hierarchical structures. It may be learned from FIG. 3 that after 5000 cycles, the material can still maintain relatively high capacitance.

### Embodiment 2

This embodiment relates to a method for preparing nitrogen-doped porous carbon, including the following steps:

Step 1: Sargassum as the raw material was washed, placed in a blow drying oven and dried at 120° C. for 48 h, pulverized, and passed through an 80 mesh sieve.

Step 2: The product obtained in the step 1 was placed in a tube furnace, heated to 800° C., and held at this temperature for 1.5 h. Argon gas was used as an inert gas.

Step 3: The product obtained in the step 2 was washed and dried.

Step 4: The product obtained in the step 3, a KOH saturated solution and polyaniline were mixed at a mass ratio of 1:5:0.3, and the mixture was ultrasonically treated for 10 min, wherein the ultrasonic frequency was 50 kHz, and the power was 100 W.

Step 5: The product obtained in the step 4 was placed in a muffle furnace for treatment at 750° C. for 2.5 h. Nitrogen gas was used as an inert gas.

Step 6: The product obtained in the step 5 was first pickled with 15 wt % hydrochloric acid, and then washed to neutrality with deionized water, and dried to obtain a nitrogen-doped biomass-based porous carbon material.

Implementation effect: The mass ratio of nitrogen atoms of the product is up to 15.4 wt %. The specific surface area calculated by the BET method is 2543 m²/g, the pore volume is 1.52 cm³/g, and the average pore size is 2.39 nm. The product is a carbon material having a high specific surface area. A constant-current charging and discharging test was performed on a supercapacitor electrode material prepared by mixing the carbon material, a conductive agent and a binder at a mass ratio of 8:1:1, using 6 mol/L KOH as an electrolyte. At a current density of 0.1 A/g, specific capacitance reaches 594 F/g. At a current density of 10 A/g, the specific capacitance can still reach 463 F/g.

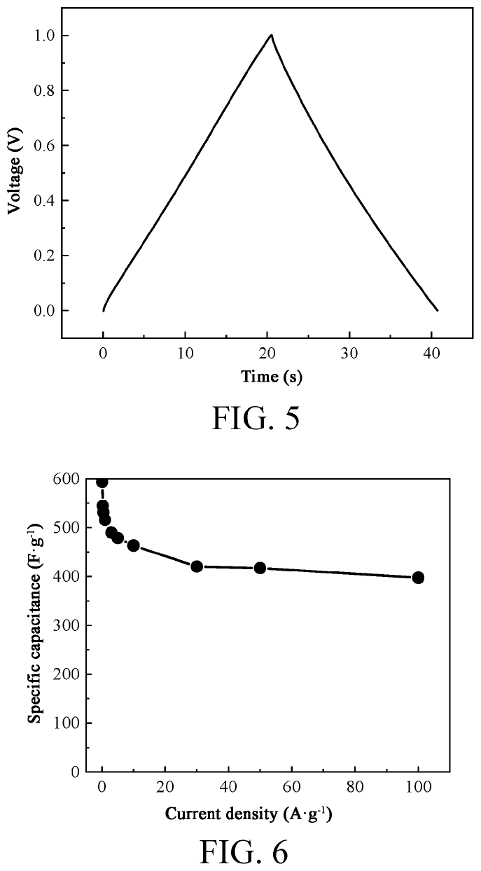

It may be learned from the shapes in FIG. 4 and FIG. 5 that the cyclic voltammetric curve of the material is approximately rectangular, and the constant-current charging and discharging curve of the material exhibits the characteristics of an isosceles triangle, indicating that the material is mainly double-layer capacitance, and nitrogen doping introduces more structural nitrogen instead of nitrogen-containing functional groups. It may be learned from FIG. 6 that the capacitance value of the material can still remain stable at a large current density, and the material has a good rate capability.

### Embodiment 3

This embodiment relates to a method for preparing nitrogen-doped porous carbon, including the following steps:

Step 1: Wood sawdust as the raw material was washed, placed in a blow drying oven and dried at 105° C. for 72 h, pulverized, and passed through a 120 mesh sieve.

Step 2: The product obtained in the step 1 was placed in a tube furnace and held at 600° C. for 2 h. Helium gas was used as an inert gas.

Step 3: The product obtained in the step 2 was washed and dried.

Step 4: The product obtained in the step 3 was mixed with a KOH saturated solution at a mass ratio of 3:1 (carbon:activator) and with pyridine at a mass ratio of 1:7 (carbon:nitrogen source), and the mixture was ultrasonically treated for 4 min, wherein the ultrasonic frequency was 30 kHz, and the power was 140 W.

Step 5: The product obtained in the step 4 was placed in a muffle furnace and held at 750° C. for 2.5 h. Ammonia gas was used as an inert gas.

Step 6: The product obtained in the step 5 was washed and dried to obtain a nitrogen-doped biomass-based porous carbon material.

Implementation effect: The mass ratio of nitrogen atoms of the product is up to 13.6 wt %. The specific surface area calculated by the BET method is 2098 m²/g, the pore volume is 1.40 cm³/g, and the average pore size is 2.14 nm. The product is a carbon material having a high specific surface area. A constant-current charging and discharging test was performed on a supercapacitor electrode material prepared by mixing the carbon material, a conductive agent and a binder at a mass ratio of 8:1:1, using 6 mol/L KOH as an electrolyte. At a current density of 0.1 A/g, specific capacitance reaches 330 F/g. At a current density of 10 A/g, the specific capacitance can still reach 260 F/g.

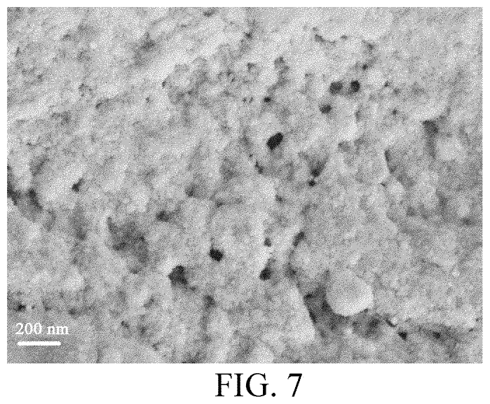

FIG. 7 is an SEM image of a nitrogen-doped porous carbon material prepared in Embodiment 3. It may be learned from the image that the material has abundant pore structures.

### Embodiment 4

This embodiment relates to a method for preparing biomass-based nitrogen-doped porous carbon, including the following steps:

Step 1: Garlic stalk as the raw material was washed, placed in a blow drying oven and dried at 120° C. for 48 h, pulverized, and passed through an 80 mesh sieve.

Step 2: The product obtained in the step 1 was placed in a tube furnace for carbonization at 600° C. for 2 h. Nitrogen gas was used as an inert gas.

Step 3: The product obtained in the step 2 was washed and dried.

Step 4: The product obtained in the step 3, KOH and melamine were mixed at a mass ratio of 1:3:0.2, and the mixture was ultrasonically treated for 8 min, wherein the ultrasonic frequency was 10 kHz, and the power was 80 W.

Step 5: The product obtained in the step 4 was placed in a muffle furnace for treatment at 800° C. for 2 h. Nitrogen gas was used as an inert gas.

Step 6: The product obtained in the step 5 was first pickled with hydrochloric acid, and then washed to neutrality with deionized water, and dried to obtain a nitrogen-doped biomass-based porous carbon material.

Implementation effect: A CO₂ adsorption test on the product under atmospheric conditions indicates that the adsorption amounts at 25° C. and 0° C. are respectively as high as 3.59 mmol/g and 6.11 mmol/g, which are quite high among the adsorption amounts of porous carbon materials.

### Embodiment 5

This embodiment relates to a method for preparing biomass-based nitrogen-doped porous carbon, including the following steps:

Step 1: Wood sawdust as the raw material was washed, placed in a blow drying oven and dried at 105° C. for 72 h, pulverized, and passed through a 120 mesh sieve.

Step 2: The product obtained in the step 1 was placed in a tube furnace and held at 600° C. for 2 h. Helium gas was used as an inert gas.

Step 3: The product obtained in the step 2 was washed and dried.

Step 4: The product obtained in the step 3 was mixed with a KOH saturated solution at a mass ratio of 3:1 (carbon:activator) and with pyridine at a mass ratio of 1:7 (carbon:nitrogen source), and the mixture was ultrasonically treated for 5 min, wherein the ultrasonic frequency was 50 kHz, and the power was 150 W.

Step 5: The product obtained in the step 4 was placed in a muffle furnace and held at 750° C. for 2.5 h. Ammonia gas was used as an inert gas.

Step 6: The product obtained in the step 5 was washed and dried to obtain a nitrogen-doped biomass-based porous carbon material.

Implementation effect: A CO₂ adsorption test on the product under atmospheric conditions indicates that the adsorption amounts at 25° C. and 0° C. are respectively as high as 3.86 mmol/g and 6.17 mmol/g, which are quite high among the adsorption amounts of porous carbon materials.

TABLE 1
Statistics on carbon sources, nitrogen sources, methods
and nitrogen doping effects in nitrogen doping patents

| | Carbon | Nitrogen | | Nitrogen | |
|---|---|---|---|---|---|
| Patent number | source | source | Method | content | |
| CN | Water | Melamine | Premixing, low-temperature | 5-9 | wt % |
| 107055531 A | chestnut | | carbonization, activation | | |
| CN | Reed rod | Nitrogen | Hydrothermal carbonization, | 6-8 | at. % |
| 107010624 A | | fertilizer | activation | | |
| CN | Soybean | Soybean meal | KOH activation | 5.63 | at. % |
| 106517183 A | meal | | | | |
| CN | Peanut shell | Melamine | Ball milling, | 8-10 | at. % |
| 106629724 A | | | low-temperature | | |
| | | | pre-carbonization, KOH | | |
| | | | activation | | |
| CN | Soy fiber | Soy fiber | Template method, potassium | 4.56 | at. % |
| 108940191 A | | | oxalate activation | | |
| CN | Biomass | Biomass | One-step “foaming method” | 3.6 | at. % |
| 106006636 A | | | | | |
| CN | Cottonseed | Urea | NaOH one-step activation | 1.84-7.35 | at. % |
| 108455597 A | husk | | | | |
| The present | Carbon-rich | Melamine, | High-temperature | 13.6-19.3 | wt % |
| invention | precursor | polyaniline, | carbonization, | | |
| | | pyrrole, | high-temperature KOH | | |
| | | pyridine | activation, hybridization | | |

Table 1 shows relevant information about carbon sources, nitrogen sources, doping methods and doping efficiency in nitrogen doping carbon material patents in recent years collected by the inventor. It is found through statistics that the existing nitrogen doping processes still have the problems of complex process and low doping efficiency.

The foregoing descriptions are merely preferred embodiments of this application, but are not intended to limit this application. Those skilled in the art may make various modifications and changes to this application. Any modification, equivalent replacement, or improvement made without departing from the spirit and principle of this application shall fall within the protection scope of this application.

1. A nitrogen-doped porous carbon material, having a specific surface area of 1600-3500 m²·g⁻¹, wherein mesopores with a pore size of 2-50 nm account for 20-40% of all pores, an average pore size is 2-20 nm, and a mass fraction of nitrogen atoms in the porous carbon material is 13.6-19.3 wt %.

2. A method for preparing a nitrogen-doped porous carbon material, comprising the following steps:
washing, drying and pulverizing a carbonaceous precursor to obtain biomass powder;
carbonizing the biomass powder at high temperature in an inert gas or ammonia gas atmosphere, to obtain a carbonized product, wherein the temperature of carbonization is 600-800° C.;
ultrasonically mixing and impregnating the carbonized product, a saturated chemical activator solution, and a nitrogen source material, wherein the nitrogen source material is melamine, polyaniline or pyridine; and
heating the impregnated product in an inert atmosphere to obtain biomass nitrogen-doped porous carbon.

3. The method for preparing a nitrogen-doped porous carbon material according to claim 2, wherein the carbonaceous precursor comprises but is not limited to garlic stalk, sargassum, wood sawdust, fruit shell and straw;
the carbonaceous precursor is passed through an 80 mesh sieve after being pulverized;
the time of the carbonization is 1.5-2.5 h;
the saturated chemical activator solution is a KOH saturated solution; and
a mass ratio of the carbonized product, the saturated chemical activator solution and the nitrogen source material is 1-3:1-5:0.1-2.

4. The method for preparing a nitrogen-doped porous carbon material according to claim 2, wherein the frequency of the ultrasonic treatment is 10-50 kHz, power of the ultrasonic treatment is 80-150 W, and the time of the ultrasonic treatment is 4-8 min.

5. The method for preparing a nitrogen-doped porous carbon material according to claim 2, wherein the temperature of the heating is 750-800° C., and the time of the heating is 2-2.5 h;
the preparation method further comprises a step of washing and drying the obtained biomass nitrogen-doped porous carbon; and
the obtained biomass nitrogen-doped porous carbon is pickled with 10-20 wt % hydrochloric acid, and then is washed to neutrality with deionized water.

6. A nitrogen-doped porous carbon prepared by the preparation method according to claim 2.

7. A method comprising applying the nitrogen-doped porous carbon according to claim 6 in preparation of a supercapacitor material.

8. An activated carbon electrode, wherein components of the activated carbon electrode comprise the nitrogen-doped porous carbon according to claim 6; and
further, the components of the activated carbon electrode further comprise a conductive agent and a binder, the conductive agent is carbon black, acetylene black, graphite or other conductive additives or is a carbon nanotube additive, and the binder is polytetrafluoroethylene (PTFE), polyvinylidene fluoride (PVDF), polyvinyl alcohol, carboxymethylcellulose sodium, polyolefin, rubber or polyurethane.

9. A method for preparing the activated carbon electrode according to claim 8, comprising the following steps:
adding a solvent to a mixture of the nitrogen-doped porous carbon, the binder and the conductive agent to prepare a slurry; and
evenly coating a current collector with the slurry and drying to obtain the activated carbon electrode; or
hot-pressing the slurry to obtain the activated carbon electrode.

10. An application of the nitrogen-doped porous carbon according to claim 6 in a CO₂ adsorbent.
